(19) United States
(12) Patent Application Publication
(10) Pub. No.: US 2013/0323705 A1
(43) Pub. Date: Dec. 5, 2013

(54) CONTENT PROVIDING SYSTEM AND CLIENT TERMINAL

(71) Applicant: Panasonic Corporation, Osaka (JP)

(72) Inventor: Atsushi MIYAZAKI, Hyogo (JP)

(73) Assignee: Panasonic Corporation, Osaka (JP)

(21) Appl. No.: 13/896,444

(22) Filed: May 17, 2013

(30) Foreign Application Priority Data
May 29, 2012 (JP) 2012-121852

(51) Int. Cl. G09B 5/00

(52) U.S. Cl. CPC G09B 5/00
USPC 434/362

(57) ABSTRACT

An exemplary content providing system includes a server in which a learning management system is established using teaching material data and a client terminal which downloads the teaching material data from the server and presents the data. The teaching material data includes teaching material management data and content data, which are associated with each other. The client terminal includes a processor which downloads the content data from the server at a predetermined time, and a storage device which stores the content data that has been downloaded. The processor downloads management data, which is associated with the content data downloaded, at or after the predetermined time, and combines the management data and the content data together according to the association between the management data and the content data, thereby generating teaching material data to present.

### BACKGROUND

1. Technical Field

The present disclosure relates to a learning system for use to learn something by information technologies, i.e., so-called “e-learning”.

2. Description of the Related Art

Lately, people pay a lot of attention to learning systems that use a communications network. Users operate such a learning system in a wireless Internet environment using a tablet or a smart phone. For example, Japanese Laid-Open Patent Publication No. 2001-242775 discloses an interactive remote learning system which enables a student to ask a question, offer comment or leave feedback to a remote lesson he or she is receiving.

These days such learning systems are generally designed to manage each individual user's learning status using a server in which a learning management system (LMS) operates.

### SUMMARY

The present disclosure provides a technique which enables a content provider to distribute content efficiently and a content receiver to use the content efficiency.

A content providing system according to an embodiment of the present disclosure includes a server in which a learning management system is established using teaching material data and a client terminal which downloads the teaching material data from the server and presents the data. The teaching material data includes teaching material management data and content data, which are associated with each other. The client terminal includes a processor which downloads the content data from the server at a predetermined time, and a storage device which stores the content data that has been downloaded. The processor downloads management data, which is associated with the content data downloaded, at or after the predetermined time, and combines the management data and the content data together according to the association between the management data and the content data, thereby generating teaching material data to present.

According to the present disclosure, teaching materials in a file format are downloaded in advance at a preset time (which may be a time when the user is not learning, for example). And when he or she sets to learning, a file that stores the identifier code of the teaching materials is downloaded, and the teaching materials that have already been downloaded are presented to him or her using that file. In this manner, the teaching materials that have been downloaded regardless of each user's learning schedule can be used handily as if the teaching materials were used according to his or her learning schedule.

These general and specific aspects may be implemented using a system, a method, and a computer program, and any combination of systems, methods, and computer programs.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

Other features, elements, processes, steps, characteristics and advantages of the present disclosure will become more apparent from the following detailed description of preferred embodiments of the present disclosure with reference to the attached drawings.

### BRIEF DESCRIPTION OF THE DRAWINGS

FIG. 1 illustrates a configuration for a learning system 1.

FIG. 2 illustrates a data structure for use to describe what runtime environment and content aggregation are.

FIG. 3 illustrates the data structure of teaching material data 104 according to an embodiment.

FIG. 4 illustrates the architecture of a learning system 1 according to this embodiment.

FIG. 5 illustrates a hardware configuration which can be used in common for all of a server 100, an administrator terminal 110 and learner terminals 120a through 120n.

FIG. 6 shows the procedure of processing of downloading the group of assets 30 before the user starts learning.

FIG. 7 shows the procedure of processing to be performed by the learning system 1 at the start of learning.

### DETAILED DESCRIPTION

An embodiment will now be described in detail, referring to the drawings. Note however that unnecessarily detailed descriptions may be omitted. For example, detailed descriptions on what are well known in the art or redundant descriptions on substantially the same configurations may be omitted. This is to prevent the following description from becoming unnecessarily redundant, to make it easier for a person of ordinary skill in the art to understand.

Note that the present inventor provides the accompanying drawings and the following description in order for a person of ordinary skill in the art to sufficiently understand the present disclosure, and they are not intended to limit the subject matter set forth in the claims.

In the past, teaching materials (or contents) provided in traditional learning management systems used to have a relatively small size. Recently, however, as Web content distribution technologies are developing more and more rapidly and extensively, an increasing number of contents provided are represented in an even broader variety of forms. As a result, those teaching materials tend to have bigger and bigger sizes. For example, nowadays it is never an uncommon case that such content is provided as a combination of video, audio and text, and some people have started to develop techniques for presenting such content by FLASH™ technology.

The present inventor recognizes a problem that would arise as an even broader variety of contents with a lot of enhanced features have been provided in increasing sizes. Specifically, the bigger the file size of given content, the longer the communication time it takes for the learner to download the teaching materials according to his or her learning schedule, thus interfering with his or her learning itself.

In addition, if a lot of learners are attempting to have access to the same server at the same time, an excessive load will be imposed on the server. Particularly, if a lot of learners are supposed to use the same learning system after school when they get home, naturally accesses to the same server will be overconcentrated in the evening or at night.

Thus, to overcome these problems, the present inventor proposes that the learners use content that has been downloaded in advance. If content has been downloaded in advance, the communication time problem, which will force each individual learner to wait patiently until the content becomes available for him or her, can be avoided and will not affect his or her learning schedule, which is beneficial. On top of that, if content has been downloaded in advance, he or she can start learning at any time he or she likes. As a result, the learner can use the content as if that content were gotten according to his or her learning schedule.

Nevertheless, if the content is teaching materials, for example, the user cannot work in close cooperation with the learning system just by downloading the teaching materials in advance. As will be described later, as far as a learning system is concerned, it is important to manage each individual learner's progress or record.

Thus, a configuration that enables the user to work in close cooperation with such a learning system will be described.

First of all, it will be described what a learning management system (LMS) is before an embodiment of the present disclosure is described.

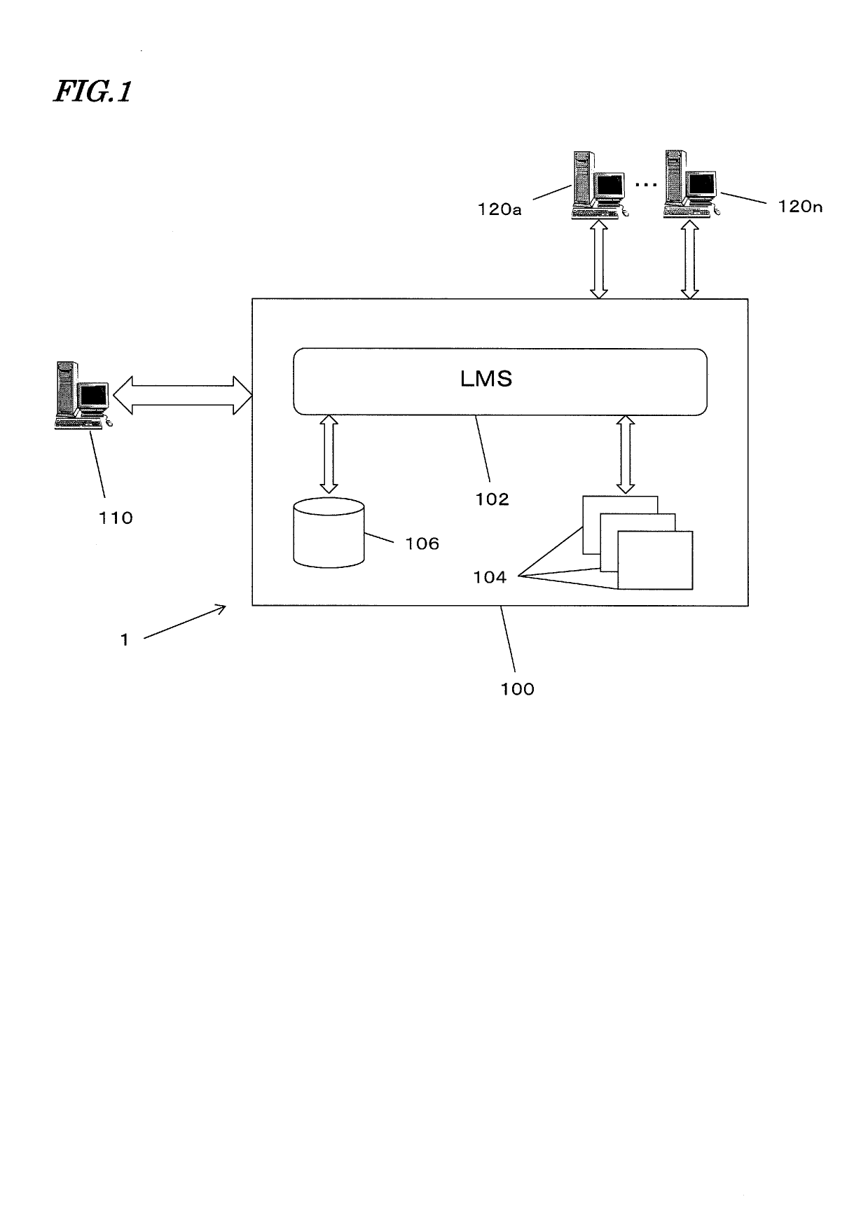

FIG. 1 illustrates a configuration for a learning system 1, which includes a server 100, an administrator terminal 110, and learner terminals 120a, 120b, . . . and 120n. In the following description, the learner terminal 120a will be taken as an example.

The server 100 is managed by a teaching material provider (i.e., the administrator). In the server 100, a learning management system (LMS) 102 has been established. The LMS 102 can be built there by installing a software program into the server 100, for example. The LMS 102 has the ability to communicate with the learner terminal 120a by using the communications capability of the server 100.

The administrator gets the learner's information (such as his or her account information), teaching material data 104 and account-by-account learning schedule registered with the server 100 through the administrator terminal 110. For example, the learner's information and his or her learning schedule are stored in a storage device 106 and the teaching material data 104 is stored in a teaching material dedicated storage device. In this description, the learning schedule means a schedule which has been arranged for the user to finish his or her lesson by a specified date using the designated teaching material data 104.

The LMS 102 manages an individual learner's account and his or her learning schedule in association with each other. For example, the LMS 102 may manage the learning schedule on an account basis. The LMS 102 presents selectable teaching material data 104 to the learner according to that schedule and transmits the teaching material data 104 that has been selected by him or her to the learner terminal 120a. After that, the LMS 102 is notified of the progress of his or her learning or the result of a test that has been carried out by the learner terminal 120a.

In addition, the LMS 102 also has the ability to manage the results of learning on an account basis. Learning result information including the history and record of learning is accumulated in the storage device 106 of the LMS 102. The administrator receives reports on the learner's record and progress from the LMS 102 through the administrator terminal 110 and uses those reports for guidance on what he or she has to do from now on.

As described above, the LMS 102 is a system that has the abilities to manage the learning schedule, provide the teaching materials, and keep the record on an account basis.

To enable the LMS 102 to handle the teaching material data 104, the teaching material data 104 should be generated in such a format that can be processed by the LMS 102. However, if the teaching material data 104 were generated in a format specific to that LMS 102, then that teaching materials could not be used as they are by other learning management systems. On top of that, in that case, the record keeping information to be exchanged between the LMS 102 and the learner terminal 120a that has presented the teaching material data 104 would lose its compatibility.

Thus, to overcome such a problem, so-called “SCORN (sharable content object reference model)” standard was established. The SCORN standard was set up to ensure reusability, accessibility, durability and interoperability for learning systems. That is to say, the SCORN standard was fixed in order to ensure compatibility even between multiple different LMS's and teaching materials by setting a rule on the communications between the LMS 102 and the learner terminal 120a.

The SCORN standard may be described roughly from the two major aspects of runtime environment and content aggregation.

### On Runtime Environment

The “runtime environment” means a software component such as an operating environment or a library which need to be used to execute a program. As described above, the LMS 102 can not only distribute the teaching material data 104 but also receive and retain the learning result information. The learning result information may be retained in the teaching material data 104 at the learner terminal 120a, for example. According to the SCORM standard, such learning result information is supposed to be transmitted and received using an API adapter program, which is provided by the LMS 102 and distributed, along with the teaching material data 104, to the learning environment. In this description, such an API adapter program is supposed to be included in the teaching material data 104.

When the learner terminal 120a retrieves the API adapter program from the teaching material data 104 and executes the program, the program will run by itself so as to transmit the learning result information to the LMS 102. On the other hand, even when the LMS 102 transmits history and other kinds of information to the learner terminal 120a that uses the teaching material data 104, the information is also transmitted and received via the API adapter program.

Since the SCORM standard defines how such an API adapter program should be provided by an LMS and how the program should work, there is no need to modify the teaching materials every time the LMS's are changed. Also, since the LMS provides an API adapter program so that communications are made between the learner terminals and the LMS using that program, there is no need to set up a communications protocol and other rules.

### On Content Aggregation

The content aggregation plays the roles of defining necessary information to circulate the teaching materials and increasing the searchability and reusability. Typically, the content aggregation means defining the structure of content by aggregating learning resources into a single combined learning unit (such as a course, a chapter or a module). In this case, the “information” includes related keywords, producer's name, version, introductory sentences and other kinds of information. These pieces of information are described in the XML format. A file described in the XML format (i.e., an XML file) and learning content are packaged together to generate a ZIP file, which is then registered with the LMS 102. In response, the LMS 102 interprets the XML files registered and generates a list of teaching material information. And by reference to such a list of registered information, any teaching material can be extracted according to the object.

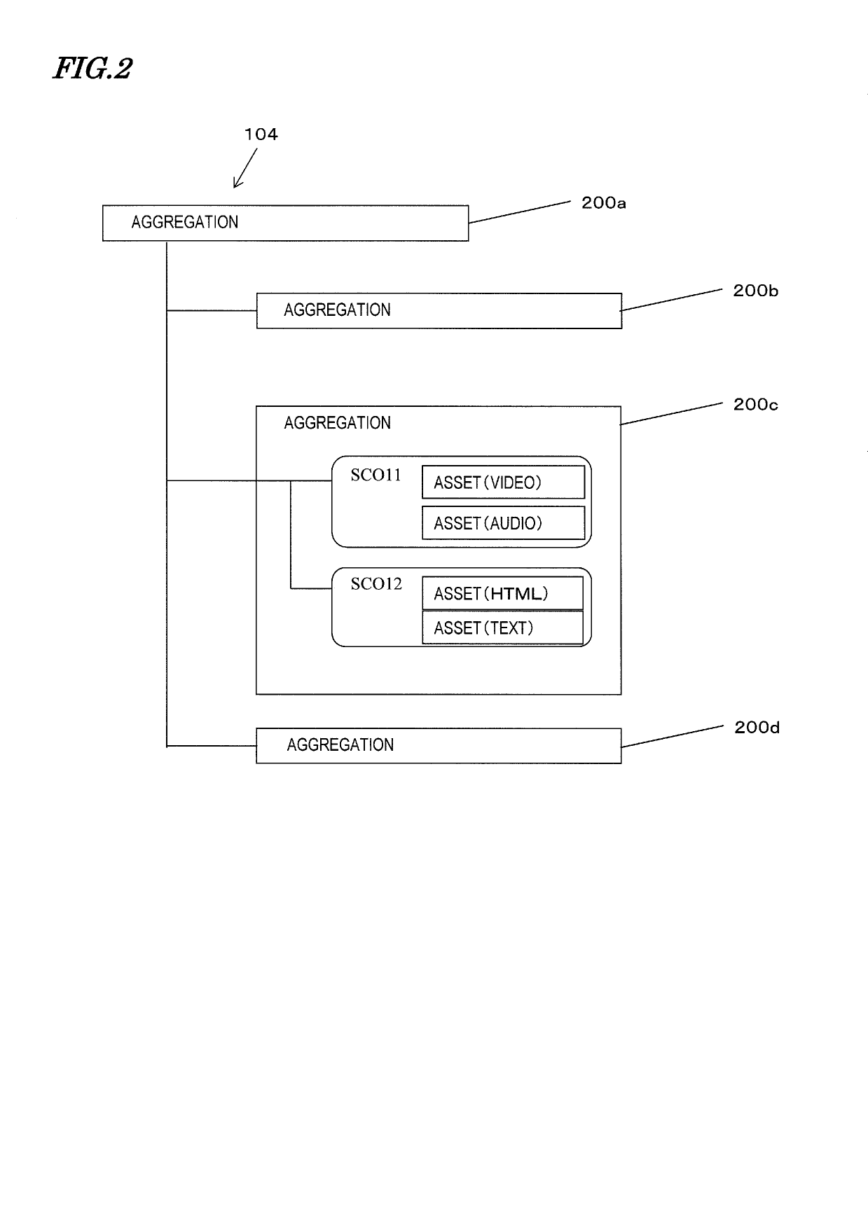

FIG. 2 illustrates a data structure for use to describe what the runtime environment and content aggregation are. The teaching material data 104 includes a plurality of aggregations 200a through 200d. In the following description, the aggregation 200c will be taken as an example.

The aggregation 200c is made up of sharable content objects (SCOs) with assets.

In this description, an “asset” refers herein to a single learning object such as a movie file, an image file, an HTML file or flash data. The attribute and feature of the asset are described with asset meta-data (not shown), and the asset can be searched for in an online repository.

Meanwhile, the “SCO” is a learning item including one or more assets and having the ability to communicate with the LMS 102. That is to say, the SCO is a learning unit for communicating with the LMS 102 using the runtime environment (API adapter program) described above. The SCO includes management data such as a learning result (or record), history and other kinds of information.

The data structure of the teaching material data 104 shown in FIG. 2 is compliant with the SCORM standard. According to this embodiment, however, the data structure of the SCORM standard is modified to carry out the processing to be described later.

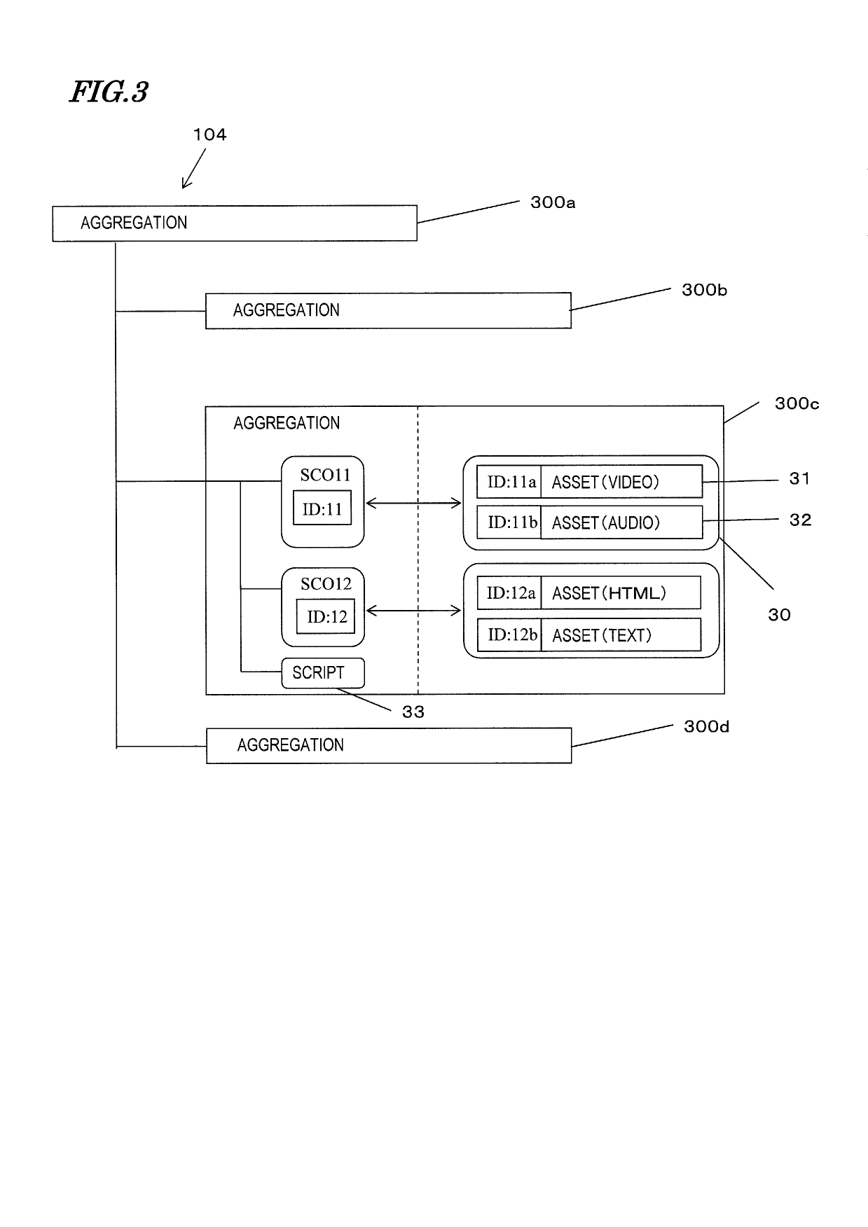

FIG. 3 illustrates the data structure of the teaching material data 104 according to this embodiment.

Unlike the data structure shown in FIG. 2, the SCOs and assets are provided separately from each other and a script 33 which describes an instruction to combine those separate SCOs and assets together is provided for the data structure shown in FIG. 3. In the following description, the SCO 11 of the aggregation 300c will be taken as an example.

In FIG. 3, the teaching material data 104 is illustrated as including a plurality of aggregations. However, this is only an example of the present disclosure. The minimum unit of the teaching material data 104 is one aggregation. That is why the teaching material data 104 only needs to include SCOs as management data and assets as content data.

In this embodiment, the SCO 11 is separated from the group of assets 30. Each of those assets in the group 30 is given an identifier code ID. Such an ID is provided to identify its original SCO 11. The ID may be given either by the producer of the teaching materials or by the LMS 102 or the server 100 following a predetermined rule when the teaching material data 104 is registered with the LMS 102.

In this embodiment, the identifier code ID of the SCO 11 is supposed to be “ID: 11” and the identifier codes ID given to its associated assets 31 and 32 are supposed to be “ID: 11a” and “ID: 11b”, respectively. That is to say, according to this embodiment, the condition is set so that the two most significant digits of the identifier code ID given to each asset agree with those of the ID of its associated SCO. The script 33 is an instruction(s) to generate teaching material data compliant with the SCORM standard (i.e., a kind of a computer program) by combining together those separate SCOs and assets which have been generated on such a condition. By giving such an identifier code ID, the identifier code ID given to each asset tells what its associated SCO is.

In this embodiment, one script 33 is supposed to be provided for each aggregation. Also, in the following description, the script 33 is supposed to be isolated from the SCO that is management data.

The group of assets is separated from the SCO so that the group of assets can be downloaded earlier to the learner terminal. As described above, an asset is a data file with a relatively large data size such as a movie file or flash data. Thus, by separating the SCO from the group of assets, only the assets can be downloaded before the user starts learning. Also, when the user sets to learning, the learner terminal receives the SCO which can communicate with the LMS 102 and executes the script 33, thereby building the aggregations of the teaching materials. Furthermore, by communicating with the LMS 102 using the SCO at the start of learning, the learner terminal can receive account information from the LMS 102 and notify the LMS 102 of the start, progress or record of learning.

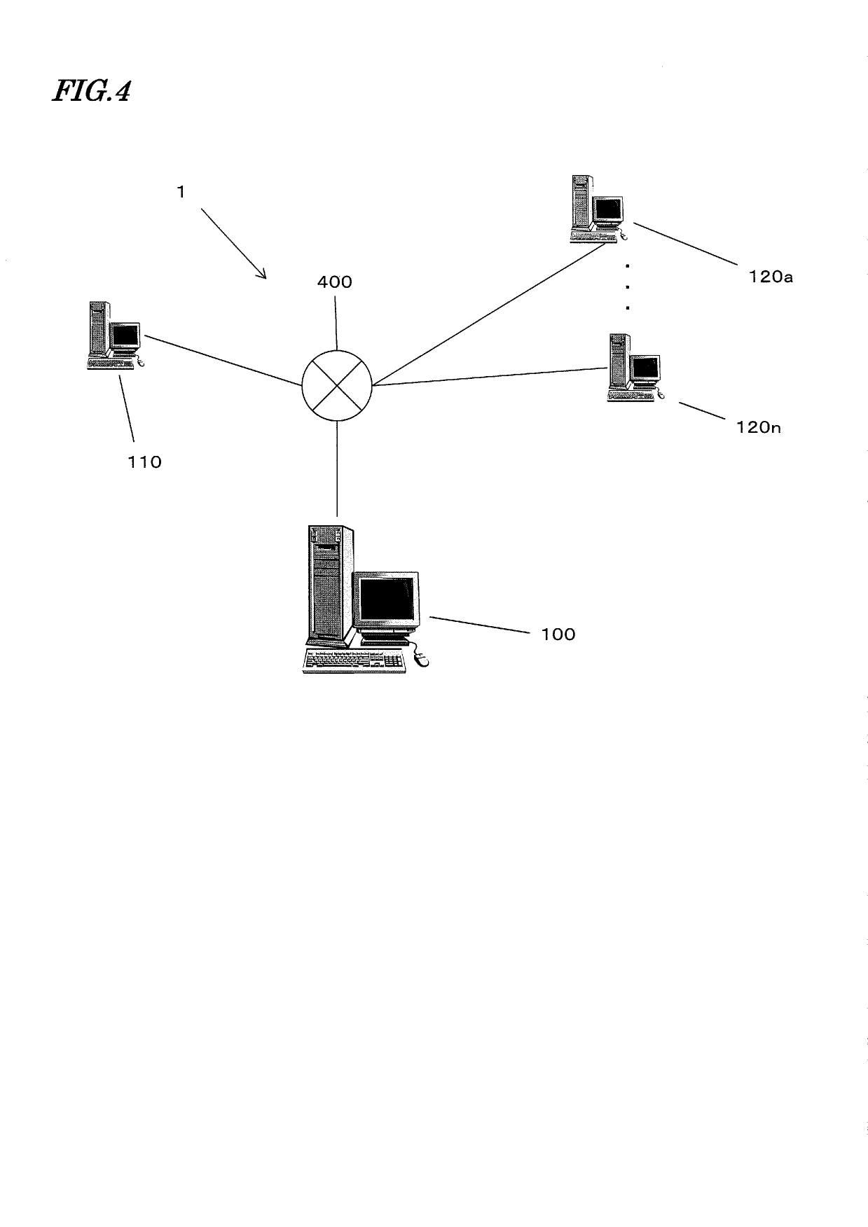

FIG. 4 illustrates the architecture of a learning system 1 according to this embodiment. The learning system 1 includes a server 100 connected to a network 400, an administrator terminal 110 and learner terminals 120a through 120n. In the server 100, the LMS 102 is established and the teaching material data 104 and the storage device 106 are provided in association with the LMS 102 as shown in FIG. 1.

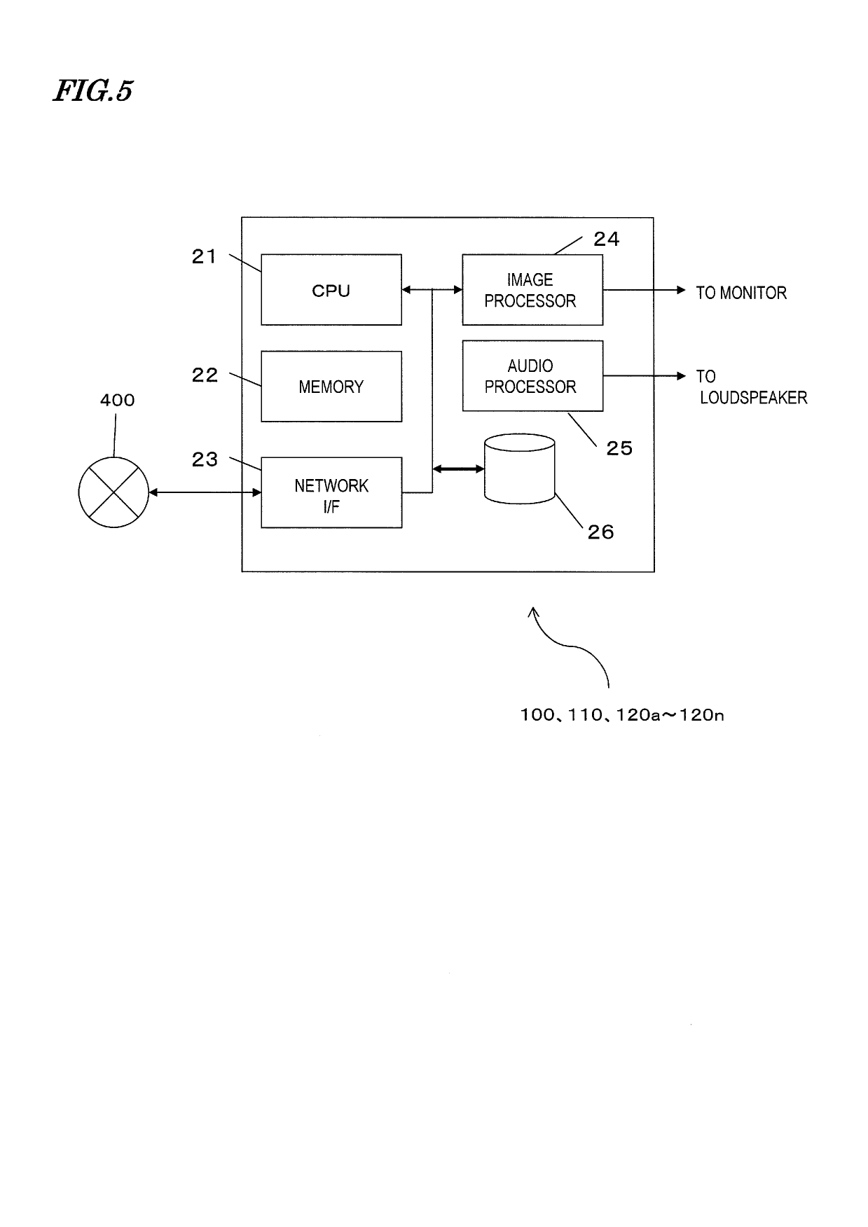

FIG. 5 illustrates a hardware configuration which can be used in common for all of the server 100, the administrator terminal 110 and the learner terminals 120a through 120n. This terminal includes a CPU 21, a memory 22, a network interface 23, an image processor 24, an audio processor 25 and a storage device 26.

The CPU 21 controls the overall operation of this terminal. The typical contents of the control operation to be performed by the CPU 21 will be described later with respect to the processing by the learning system 1. The memory 22 is a semiconductor storage device which stores a program, data and so on. The network interface (I/F) 23 transmits and receives information over the network 400 such as the Internet. If this terminal is the server 100, the network I/F 23 exchanges data with the learner terminals 120a through 120n over the network 400.

The image processor 24 is a circuit dedicated to image processing and may be a so-called GPU, for example. Meanwhile, the audio processor 25 is a circuit dedicated to audio processing.

The storage device 26 may be a hard disk drive, for example, and may store the teaching material data 104.

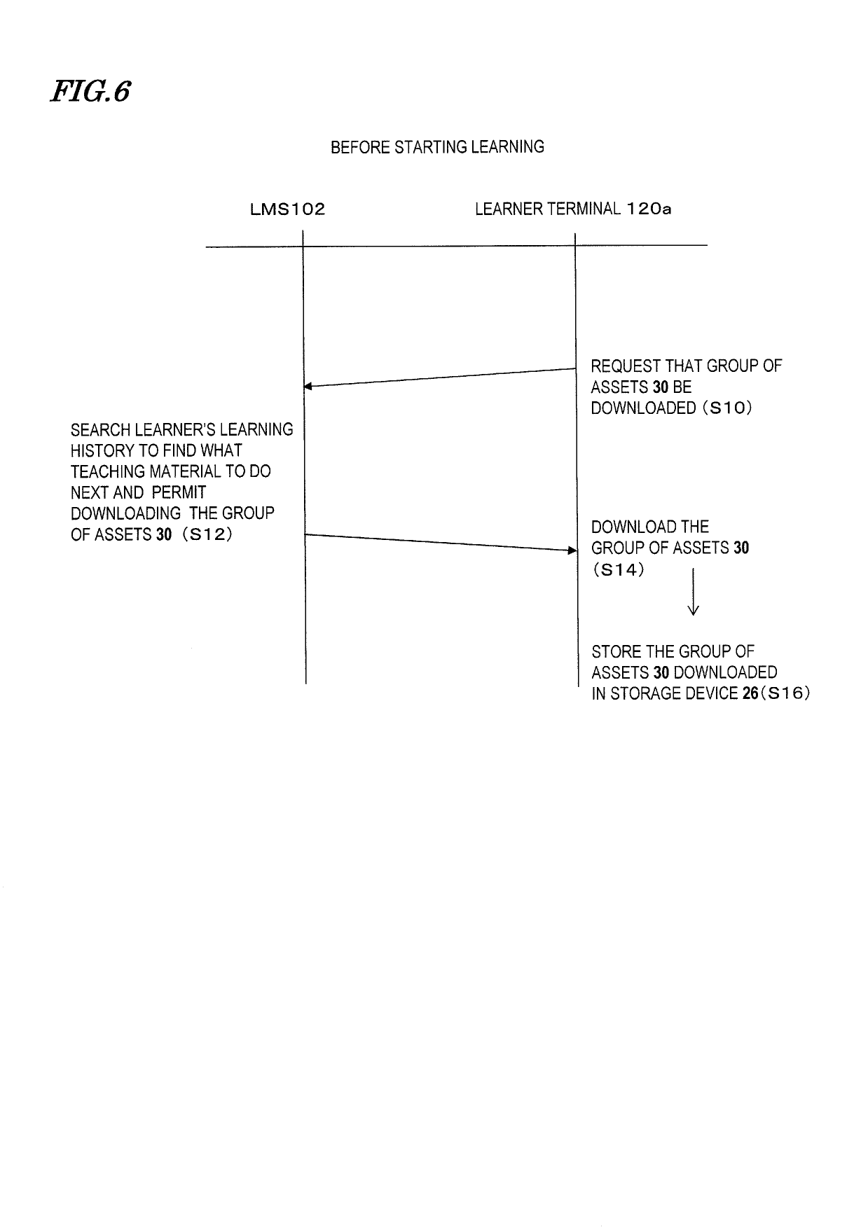

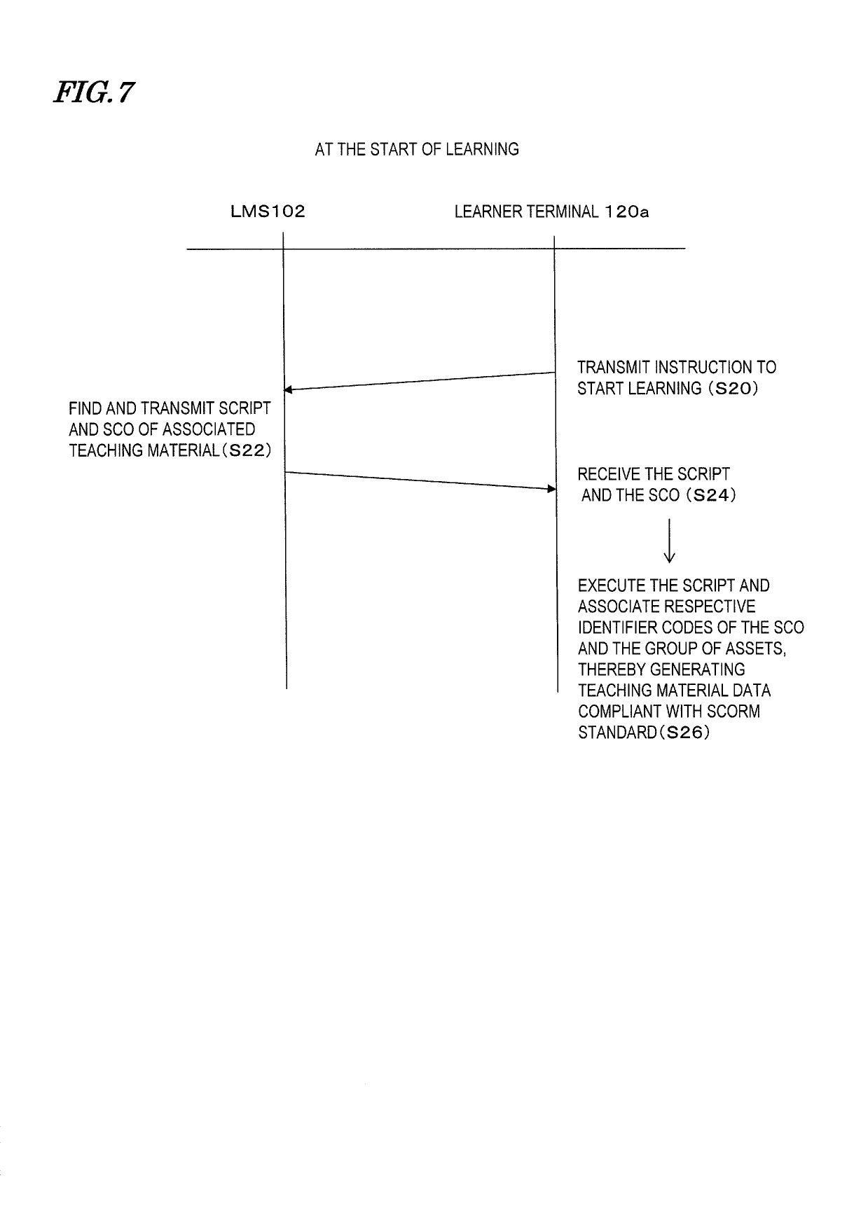

Hereinafter, it will be described with reference to FIGS. 6 and 7 how the LMS 102 and learner terminal 120a according to this embodiment operate.

FIG. 6 shows the procedure of processing of downloading the group of assets 30 before the user starts learning.

First of all, in Step S10, a scheduler, which is one of the programs (or services) executed by the CPU 21 of the learner terminal 120a, requests the LMS 102 that the group of assets 30 be downloaded. This request may be made at any arbitrary time, which is a preset time that is earlier than a time when the user sets to learning with the teaching materials. For example, the preset time may be in a midnight time zone when the load on the network should be relatively light. In this processing step, the scheduler also transmits the account information of the learner who is using this learner terminal 120a.

Next, in Step S12, on receiving the download request, the LMS 102 searches the learner's learning history with his or her account information to find the teaching material data 104 of the teaching material that he or she should take on next, and permits the learner terminal 120a to download the group of assets 30. Subsequently, in Step S14, the scheduler of the learner terminal 120a downloads the group of assets 30 by permission.

Then, in Step S16, the learner terminal 120a stores the group of assets 30 downloaded in the storage device 26.

FIG. 7 shows the procedure of processing to be performed by the learning system 1 at the start of learning.

At the start of learning, the CPU 21 of the learner terminal 120a executes the teaching material presentation program in accordance with the learner's instruction.

In Step S20, the CPU 21 of the learner terminal 120a that has executed the presentation program transmits an instruction to start learning to the LMS 102 following the operating procedure of the presentation program. In this processing step, the learner terminal 120a also transmits the account information of the learner who is using that learner terminal 120a.

Next, in Step S22, on receiving the instruction to start learning, the LMS 102 finds the script and SCO of the teaching material to use by reference to the account information and transmits them.

Then, in Step S24, the learner terminal 120a receives the script 33 and the SCO. Subsequently, in Step S26, the CPU 21 of the learner terminal 120a executes the script 33, associates the respective identifier codes of the SCO and the group of assets with each other in accordance with the instruction described in the script 33 and combines the SCO and group of assets that have been associated with each other, thereby generating teaching material data compliant with the SCORM standard. In this manner, the teaching material data compliant with the SCORM standard can be presented following this presentation program.

Optionally, in Step S20, the learner terminal 120a may transmit the identifier code assigned to the group of assets 30 instead of, or along with, the account information. If a unique identifier code is assigned to every teaching material data 104, then the LMS 102 can identify the script and the SCO by the identifier code.

In this embodiment, the learner terminal is supposed to download video data or any other data with a relatively large data size (i.e., the group of assets) before the user starts learning. As for the SCO, on the other hand, the learner terminal is supposed not to download it but to obtain it along with the script at the start of learning. By downloading the script and the SCO at the start of learning, the learner can use this learning system 1 as if he or she used the teaching materials according to his or her learning schedule. In addition, on receiving the instruction to start learning, the LMS can manage the log indicating when the teaching material data (typically, the SCO) was accessed, i.e., information indicating when the learner took on that teaching material. On top of that, by making communications using the SCO, the LMS can make record keeping and confirm the learner's progress with respect to that teaching material. It should be noted that these are quite different from simply downloading the entire content compliant with the SCORM standard in advance.

Optionally, the group of assets representing the teaching materials may be encrypted and the script may include a decoding key so that the teaching materials cannot be decoded until the script is obtained.

In the embodiment described above, the script 33 is supposed to be isolated from the SCO that is management data. However, this is only an example. Alternatively, the script 33 may be included in at least one SCO in each aggregation.

Also, in the embodiment described above, a learning system and an LMS are supposed to be used, and those systems are supposed to be compliant with the SCORM standard, in particular. However, this is just an example. The SCORM standard does not have to be adopted.

Furthermore, the processing described above is also applicable effectively to any other distribution system which distributes data of a relatively large size. For example, the operations described above can be performed even in a game distribution system from which data of the next stage is downloaded depending on the degree of progress. Still alternatively, the operations described above can also be performed even in a video distribution system which gets a series of soap opera to be telecast every day downloaded by a specified date and which requires to execute a script to allow the viewer to play back the content at or after a predetermined time the day following the specified date.

If the processing described above is used in those various other applications, then the learner terminals may be just replaced with “client terminals” and the LMS may be just replaced with a “game management system”, or the like. That is to say, it should be noted that the present disclosure is used in not only the learning system described above but also various other data distribution systems as well.

A content providing system 1 according to an embodiment of the present disclosure includes a server 100 in which a learning management system 102 is established using teaching material data 104 and a client terminal 120a which downloads the teaching material data 104 from the server 100 and presents the data. The teaching material data 104 includes teaching material management data 11 and content data 30, which are associated with each other. The client terminal 120a includes a processor 21 which downloads the content data 30 from the server 100 at a predetermined time, and a storage device 26 which stores the content data 30 that has been downloaded. The processor 21 downloads management data 11, which is associated with the content data 30 downloaded, at or after the predetermined time, and combines the management data 11 and the content data 30 together according to the association between the management data 11 and the content data 30, thereby generating teaching material data 104 to present.

In one embodiment, the teaching material data 104 further includes a script 33 which describes an instruction to combine the management data 11 and the content data 30 that are associated with each other, and the processor 21 of the client terminal 120a executes the script 33, thereby combining the management data 11 and the content data 30 together and presenting data thus obtained.

In this particular embodiment, the script 33 is included in the management data 11.

In another embodiment, the teaching material data 104 to present is compliant with the SCORM standard.

In still another embodiment, the content data 30 is encrypted and the script 33 includes a decoding key.

In yet another embodiment, the predetermined time is a preset time and the processor 21 of the client terminal 120a downloads the content data 30 from the server 100 at the preset time which is prior to a time to present the teaching material data 104 according to a learning schedule.

In this particular embodiment, the management data 11 retains a result of learning, and the processor 21 adds the record of each learner, who has gotten the teaching material data 104 presented, to the management data 11.

A client terminal 120a according to an embodiment of the present disclosure downloads teaching material data 104 from a server 100, where the teaching material data 104 is stored and where a learning management system 102 is established using the teaching material data 104, and presents the teaching material data 104. The teaching material data 104 includes teaching material management data 11 and content data 30, which are associated with each other. The client terminal 120a includes a processor 21 which downloads the content data 30 from the server 100 at a predetermined time, and a storage device 26 which stores the content data 30 that has been downloaded. The processor 21 downloads management data 11, which is associated with the content data 30 downloaded, at or after the predetermined time, and combines the management data 11 and the content data together according to the association between the management data 11 and the content data 30, thereby generating teaching material data 104 to present.

In one embodiment, the teaching material data 104 further includes a script 33 which describes an instruction to combine the management data 11 and the content data 30 that are associated with each other, and the processor 21 of the client terminal 120a executes the script 33, thereby combining the management data 11 and the content data 30 together and presenting data thus obtained.

In this particular embodiment, the content data 30 is encrypted, the script 33 includes a decoding key, and the processor 21 decodes the content data 30 with the key.

In another embodiment, the predetermined time is a preset time and the processor 21 of the client terminal 120a downloads the content data 30 from the server 100 at the preset time which is prior to a time to present the teaching material data 104 according to a learning schedule.

In still another embodiment, the management data 11 retains a result of learning, and the processor 21 adds the record of each learner, who has gotten the teaching material data 104 presented, to the management data 11.

A content providing system according to the present disclosure can be used effectively in not only a learning system that needs to get data of a relatively large size downloaded but also a game distribution system and a video distribution system to which the data distributing method and progress management scheme of the learning system are applied.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

This application is based on Japanese Patent Application No. 2012-121852 filed on May 29, 2012, the entire contents of which are hereby incorporated by reference.

What is claimed is:

1. A content providing system comprising a server in which a learning management system is established using teaching material data and a client terminal which downloads the teaching material data from the server and presents the data,
wherein the teaching material data includes teaching material management data and content data, which are associated with each other, and
wherein the client terminal includes
a processor which downloads the content data from the server at a predetermined time, and
a storage device which stores the content data that has been downloaded,
wherein the processor downloads management data, which is associated with the content data downloaded, at or after the predetermined time, and combines the management data and the content data together according to the association between the management data and the content data, thereby generating teaching material data to present.

2. The content providing system of claim 1, wherein the teaching material data further includes a script which describes an instruction to combine the management data and the content data that are associated with each other, and
wherein the processor of the client terminal executes the script, thereby combining the management data and the content data together and presenting data thus obtained.

3. The content providing system of claim 2, wherein the script is included in the management data.

4. The content providing system of one of claim 1, wherein the teaching material data to present is compliant with the SCORM standard.

5. The content providing system of one of claim 2, wherein the teaching material data to present is compliant with the SCORM standard.

6. The content providing system of one of claim 3, wherein the teaching material data to present is compliant with the SCORM standard.

7. The content providing system of claim 2, wherein the content data is encrypted and the script includes a decoding key.

8. The content providing system of claim 1, wherein the predetermined time is a preset time and wherein the processor of the client terminal downloads the content data from the server at the preset time which is prior to a time to present the teaching material data according to a learning schedule.

9. The content providing system of claim 8, wherein the management data retains a result of learning, and
wherein the processor adds the record of each learner, who has gotten the teaching material data presented, to the management data.

10. A client terminal which downloads teaching material data from a server, where the teaching material data is stored and where a learning management system is established using the teaching material data, and which presents the teaching material data,
wherein the teaching material data includes teaching material management data and content data, which are associated with each other, and
wherein the client terminal includes
a processor which downloads the content data from the server at a predetermined time, and
a storage device which stores the content data that has been downloaded,
wherein the processor downloads management data, which is associated with the content data downloaded, at or after the predetermined time, and combines the management data and the content data together according to the association between the management data and the content data, thereby generating teaching material data to present.

11. The client terminal of claim 10, wherein the teaching material data further includes a script which describes an instruction to combine the management data and the content data that are associated with each other, and
wherein the processor of the client terminal executes the script, thereby combining the management data and the content data together and presenting data thus obtained.

12. The client terminal of claim 11, wherein the content data is encrypted, the script includes a decoding key, and the processor decodes the content data with the key.

13. The client terminal of claim 10, wherein the predetermined time is a preset time and wherein the processor of the client terminal downloads the content data from the server at the preset time which is prior to a time to present the teaching material data according to a learning schedule.

14. The client terminal of claim 13, wherein the management data retains a result of learning, and
wherein the processor adds the record of each learner, who has gotten the teaching material data presented, to the management data.
